(19) United States
(12) Patent Application Publication
(10) Pub. No.: US 2007/0183466 A1
(43) Pub. Date: Aug. 9, 2007

(54) Laser display device

(75) Inventors: Joong-kon Son, Seoul (KR); Jeong-wook Lee, Seongnam-si (KR); Ho-sun Paek, Suwon-si (KR); Sung-nam Lee, Suwon-si (KR); Tan Sakong, Suwon-si (KR)

Correspondence Address: BUCHANAN, INGERSOLL & ROONEY PC, POST OFFICE BOX 1404, ALEXANDRIA, VA, 22313-1404, US

(73) Assignee: SAMSUNG ELECTRONICS CO., LTD., Suwon-si (KR)

(21) Appl. No.: 11/513,224

(22) Filed: Aug. 31, 2006

(30) Foreign Application Priority Data
Feb. 9, 2006 (KR) 10-2006-0012603

(51) Int. Cl. H01S 3/10; H01S 3/00

(52) U.S. Cl. 372/24; 372/9; 372/38.1

(57) ABSTRACT

A laser display device is provided which includes: a light source emitting at least one laser beam; a light modulation unit for modulating the laser beam emitted from the light source according to an image signal; a scanning unit scanning the laser beam modulated in the light modulation unit in a main scanning direction and in a sub-scanning direction; and an image unit in which an image is formed having a phosphor layer in which excitation light is generated by a laser beam scanned by the scanning unit.

### CROSS-REFERENCE TO RELATED PATENT APPLICATION

This application claims the benefit of Korean Patent Application No. 10-2006-0012603, filed on Feb. 9, 2006, in the Korean Intellectual Property Office, the disclosure of which is incorporated herein in its entirety by reference.

### BACKGROUND OF THE DISCLOSURE

1. Field of the Disclosure

The present disclosure relates to a laser display device, and more particularly, to a laser display device using light of a phosphor layer excited by a laser beam.

2. Description of the Related Art

A display device displays an image represented by an electric signal. An example of a conventional display device is a cathode ray tube (CRT).

A CRT uses the luminescence of phosphor materials excited by electron beams. This principle is called cathode luminescence by electron beams. When using a cathode ray, it is difficult to reduce the thickness of the CRT or provide a large screen due to limitations in the structure of the vacuum tube and a deflection yoke which deflects electron beams, and the brightness thereof is also limited.

Projection type laser display devices have recently been developed. These displays scan red, green, and blue laser beams onto a screen. Since these laser displays use a high intensity laser as a light source, they can provide a sharp, high contrast image. However, projection type laser display devices commonly exhibit an undesirable speckle appearance due to the high coherency of the laser beams. Speckle is noise which is a predetermined interference pattern formed on the retina that is diffused by the rough surface of the screen and enters the eye when the laser beam is reflected on the surface of the screen.

### SUMMARY OF THE DISCLOSURE

The present invention may provide a laser display device using excitation resulting from a laser beam.

According to an aspect of the present invention, there may be provided a laser display device comprising: a light source emitting at least one laser beam; a light modulation unit for modulating the laser beam emitted from the light source according to an image signal; a scanning unit scanning the laser beam modulated in the light modulation unit in a main scanning direction and in a sub-scanning direction; and an image unit in which an image is formed having a phosphor layer in which excitation light is generated by a laser beam scanned by the scanning unit.

### BRIEF DESCRIPTION OF THE DRAWINGS

The above and other features and advantages of the present invention will be illustrated in detailed exemplary embodiments thereof with reference to the attached drawings in which:

FIG. 1 illustrates the optical arrangement of a laser display device according to an embodiment of the present invention;

FIG. 2 illustrates a scanning unit of FIG. 1 according to an embodiment of the present invention;

FIG. 3A is a cross-sectional view of part of an image unit of FIG. 1;

FIG. 3B illustrates phosphors formed in a phosphor layer in FIG. 3A;

FIG. 4A illustrates the optical arrangement of a laser display device according to another embodiment of the present invention;

FIG. 4B is a view taken from a rear surface of the image unit of FIG. 4A;

FIG. 5A illustrates the optical arrangement of a laser display device according to another embodiment of the present invention; and

FIG. 5B is a view taken from a rear surface of the image unit of FIG. 5A.

### DETAILED DESCRIPTION OF EXEMPLARY EMBODIMENTS

The present invention will now be described with reference to the accompanying drawings, which show exemplary embodiments of the invention.

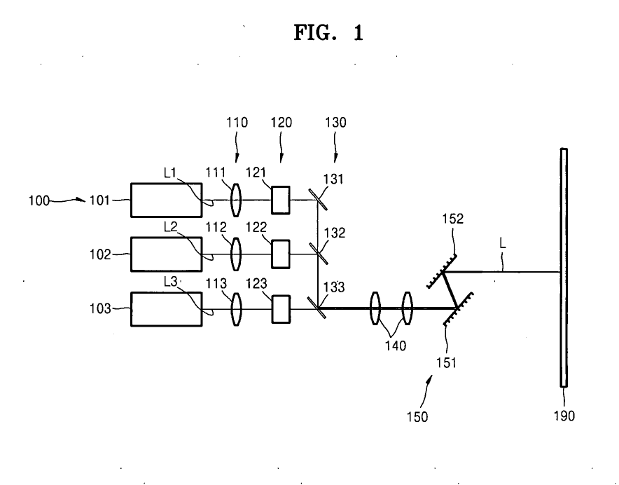

FIG. 1 is a schematic view of a laser display device according to an embodiment of the present invention. Referring to FIG. 1, the laser display device includes a light source 100 emitting a laser beam L, a light modulation unit 120 modulating the laser beam L according to an image signal, a light path converter 130 converting the light path to focus the modulated laser beams L from the light modulation unit 120, a scanning unit 150 scanning the modulated laser beams L, and an image unit 190 forming an image using excitation light generated by the scanned laser beams L.

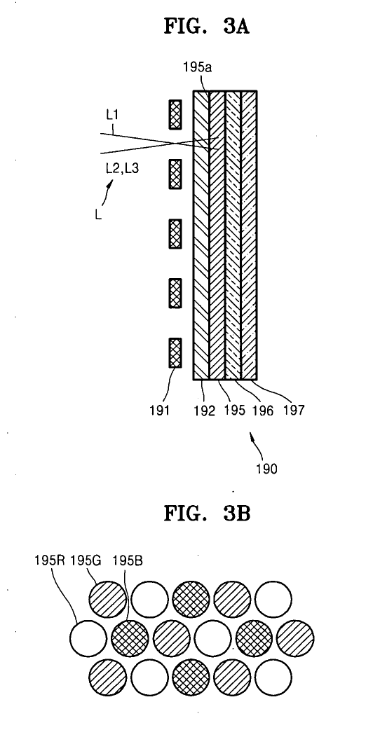

The light source 100 is a laser emitting a laser beam L in the UV range. The light source 100 may be, for example, a nitride type semiconductor laser diode. The laser beam L emitted from the light source 100 generates photoluminescence in a phosphor (195 in FIG. 3A), which will be described hereafter, to produce an image. In the present embodiment, the light source 100 includes first through third laser diodes 101, 102, and 103 emitting first through third laser beams L1, L2, and L3 for producing a color image.

A collimating optical system 110 may be further formed to collimate the laser beam L emitted from the light source 100. The collimating optical system 100 is located between the light source 100 and the light modulation unit 120 and includes first through third collimating lenses 111, 112, and 113 for modulating the first through third laser beams L1, L2, and L3.

A focusing lens (not shown) may be further included between the collimating optical system 110 and the light modulation unit 120, to focus the laser beam L to the desired size for the light modulation unit 120.

The light modulation unit 120 modulates the laser beam L according to image signals provided by an image signal generation unit (not shown). The light modulation unit 120 includes first through third light modulation units 121, 122, and 123, which respectively receive the red, green, and blue components of the image signal. The light modulation unit 120 may be, for example, a light blocking switch, such as an acousto-optic modulator.

The light path converter 130 collects first through third laser beams which are respectively modulated in the first through third light modulation units 121, 122, and 123 into one beam and directs the beam to the scanning unit 150. For this, the light path converter 130 includes first and second dichroic mirrors 132 and 133. In the present embodiment, a reflective mirror 131 is further included such that the first laser diode 101, the first collimating lens 111, and the first light modulation unit 121 can be located together with other optical devices.

The reflective mirror 131 reflects the first laser beam L1. The first dichroic mirror 132 transmits the first laser beam L1 and reflects the second laser beam L2. The second dichroic mirror 133 reflects the first and second laser beams L1 and L2 and transmits the third laser beam L3. The first through third laser beams L1, L2, and L3 which have passed through the second dichroic mirror 133 form an optical bundle while each remaining separately therein and are simultaneously scanned onto the scanning unit 150.

A focusing optical system 140 may be further included so that the first through third laser beams L1, L2, and L3 which are collected into one in the light path converter 130 can be scanned with the proper beam pitch onto an image unit 190. The focusing optical system 140 is located between the light path converter 130 and the scanning unit 150. When the present embodiment uses a shadow mask (191 in FIG. 3A), the focusing optical system 140 focuses the first through third laser beams L1, L2, and L3 such that they can meet in the holes of the shadow mask 191 and then be scanned on the image unit 190 in various different directions, as will be described hereafter.

The scanning unit 150 includes a sub-scanning scanner 151 scanning the incident laser beam L in a sub-scanning direction (vertically) and a main scanning scanner 152 scanning the incident laser beam L in a scanning direction (horizontally). The relative positions of the sub-scanning scanner 151 and the main scanning scanner 151 may be exchanged.

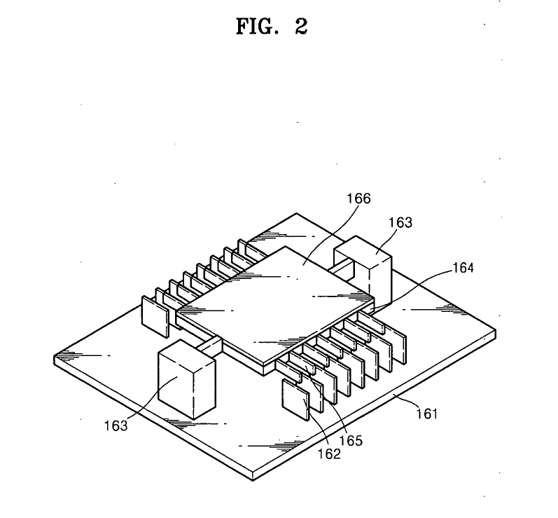

The scanning unit 150 includes at least one micro-scanner having a rotatable mirror. FIG. 2 illustrates a one axis driving micro-scanner as an example. Referring to FIG. 2, the micro-scanner includes a substrate 161, a fixed comb electrode 162 formed on the substrate 161, a supporting structure 163, a stage 164 suspended by the supporting structure 163, and a moving comb electrode 165 formed on a first surface of the stage 164 and meshing with the fixed comb electrode 162. A mirror 166 is formed on a second surface of the stage 164. The micro-scanner can be driven electrostatically using the comb electrode. A pair of one axis driving micro-scanners is formed, one as a main scanning scanner 151 and the other as a sub-scanning scanner 152.

Alternatively, the scanning unit 150 (see FIG. 1) can include a two axis driving micro-scanner to perform scanning in the main scanning direction and in the sub-scanning direction with one unit at the same time. For the two axis driving, the stage has a double suspension structure, and each axis includes a comb electrode structure.

When such a micro-scanner is used, light is scanned by minute rotations of the mirror 166, and can thus sweep at a high speed of more than about 75 Hz. With such fast sweeping, the laser display device in the present embodiment has a higher contrast ratio than the conventional CRT or LCD.

The light reflected from the scanning unit 150 is scanned onto the image unit (190 in FIG. 1). FIG. 3A is a cross-sectional view of part of the image unit 190. Referring to FIG. 3A, the image unit 190 includes a shadow mask 191, a UV transmitting filter 192, a phosphor layer 195, a UV blocking filter 196, and an anti-reflection layer 197.

The shadow mask 191 is separated a predetermined distance from the phosphor layer 195 and includes a plurality of holes corresponding to the pixels formed in the phosphor layer 195. The first through third laser beams L1, L2, and L3 are scanned onto the image unit 190, meet in the holes of the shadow mask 191, and are separated in different directions to strike red, green, and blue phosphors in the phosphor layer 195.

The UV transmitting filter 192 is located at a surface of incidence 195a of the laser beam and transmits only the UV component of the laser beam L. The UV transmitting filter 192 preferably transmits only the component of the laser beam L which is within the absorption wavelength range of the phosphor layer 195, as will be described hereafter. Accordingly, the laser beams outside the absorption wavelength range which do not excite the phosphor layer 195 are blocked, thereby improving the color quality and contrast.

The phosphor layer 195 uses photoluminescence generated by the laser beam in the UV wavelength range. Examples of photoluminescence are fluorescence and phosphorescence, where a material is excited by light to emit light. Luminescence is the phenomenon in which a material is excited by absorbing energy such as light, electricity, or radial rays, and then emits the absorbed energy as light by returning to the ground state. Light emission by photostimulation requires that the wavelength of the input light is in the light absorption range of the phosphors. As the excited light by photoluminescence generally has the same or longer wavelength as the input light, light in the visible range can be produced using a UV laser beam.

The phosphor layer 195 includes three phosphors respectively having red, green, and blue light emitting colors (195R, 195G, and 195B in FIG. 3B), and emits red, green, and blue excitation light when excited by the first through third laser beams L1, L2, and L3. The three phosphors 195R, 195G, and 195B are located where the first through third laser beams L1, L2, and L3 are shed respectively. FIG. 3B illustrates the phosphors 195R, 195G, and 195B according to an embodiment of the present invention. Each trio of red, green, and blue phosphors 195R, 195G, and 195B together form one pixel. The red, green, and blue excitation lights respectively form red, green, and blue images at the same time on the phosphor layer 195, and these are synthesized visually to create a color image. Since the degree of divergence of the laser beam L is very small, the laser beam L can be highly collimated and the size of the pixel can be small, thereby allowing a better resolution than an LCD. Also, the intensity of the excitation light emitted from the phosphor layer 195 is in proportion to the intensity of the radiated laser beam L, and the color can be controlled by controlling the light output of each of the laser diodes 101, 102, and 103.

As the laser display device according to an embodiment of the present invention uses photoluminescence caused by the laser beam L, the laser display device has a much higher brightness than a conventional display device. An LCD has a brightness of approximately 150 to 200 cd/m2 and a CRT has a brightness of approximately 120 cd/m2. On the other hand, when the laser display device of the present embodiment includes an image unit having a size of 40 inches and a resolution of 1064×764, each pixel is 1 mm2 or smaller, and when a 1 mW GaN laser diode is radiated onto the green phosphor, green light of 550 nm is emitted at brightness of about 1×103 lm/m2, which equates to 680,000 cd/m2. Accordingly, the present invention can provide a very high brightness and a clean image, both indoors and outdoors where the external light is intense.

Since the laser beam L is not scanned directly onto the screen but is scanned indirectly through the photoluminescence onto the screen, the laser display device according to an embodiment of the present invention provides a solution to the problem of a speckle appearance which is caused by the coherence of the laser beam.

The anti-reflection layer 197 is located on the opposite surface of the UV blocking filter 196 contacting the phosphor layer 195. The anti-reflection layer 197 prevents light from outside the image unit 190 from being reflected, thereby suppressing glare.

The UV blocking filter 196 is located on the opposite surface of the incident surface 195a of the laser beam of the phosphor layer 195. The UV blocking filter 196 blocks the UV wavelength range of the laser beam L which has passed through the phosphor layer 195, and transmits the visible light emitted by the phosphor layer 195.

In the previous embodiments of the present invention, laser display devices using three laser diodes for displaying colors have been described, but the present invention is not so limited. For example, one laser diode can be used to produce a single color, or three or more laser diodes can be used to produce an image having a color more closely similar to a natural color.

Also, a method using a shadow mask has been described, but various other methods developed for CRTs may be applied when practicing the present invention.

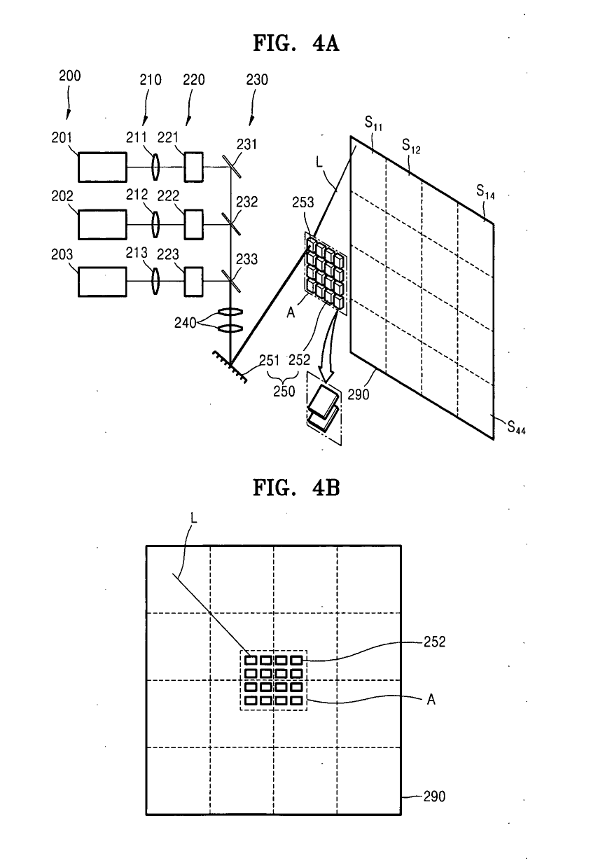

FIG. 4A is a schematic view of a laser display device according to another embodiment of the present invention. FIG. 4B is a view taken from the rear surface of an image unit, illustrating the image unit and a second scanning unit. The present embodiment illustrates a laser display device having a large screen which is applied from the embodiment of FIG. 1.

Referring to FIG. 4A, the laser display device of the present embodiment includes a light source 200, a light modulation unit 220, a light path converter 230, a scanning unit 230, and an image unit 290. Optical systems 210 or 240 collimating or focusing light may be further included between the light source 200 and the light modulation unit 220 or between the light path converter 230 and the scanning unit 250. The light source 200 includes first through third laser diodes 201, 202, and 203 for producing color. The light modulation unit 220 includes first through third light modulation units 221, 222, and 223 modulating the laser beam according to image signals. The light path converter 230 include a reflective mirror 231 and first and second dichroic mirrors 232 and 233 to direct the three laser beams L from the light modulation unit 220 to the scanning unit 250. The description of the components of the present embodiment common to those in the previous embodiment of FIG. 1 having substantially equal function and configuration are not being repeated.

In the present embodiment, to produce a large screen, the image unit 290 is virtually divided into M×N. The scanning unit 250 includes a second scanning unit 252 including M×N sub-scanners 253 corresponding to each of the divided regions S11,S12, . . . ,SMN and a first scanning unit 251 scanning a laser beam onto the second scanning unit 252. In FIGS. 4A and 4B, M is 4 and N is 4.

The first scanning unit 251 and the sub-scanners 253 may be micro-scanners having rotatable mirrors as described with reference to FIG. 2. The first scanning unit 251 and the sub-scanners 253 may be two one axis driving micro-scanners or one two axis driving micro-scanner. The first scanning unit 251 illustrated in FIG. 4A is a two axis driving micro-scanner, and the sub-scanners 253 are formed in pairs of one axis driving micro-scanners. However, the present invention is not so limited.

The sub-scanners 253 are separated from the rear surface of the image unit 290 and arranged in a matrix of M×N on a virtual scanning surface A. The laser beam L is scanned onto the rear surface of the image unit 290. Each of the sub-scanners 253 is a different distance from the image unit 290, and the size of the scannable regions the sub-scanners 253 may vary, and thus the present invention is not limited to the divided regions of the image unit 290 being of an equal surface area. Likewise, the sub-scanners 253 may be spaced equally or unequally on the sub-scanning surface A.

The first scanning unit 251 scans the laser beam L formed in the light path converter 230 onto the sub-scanning surface A in a main scanning direction and in a sub-scanning direction so that the laser beam L can be directed to the sub-scanners 253.

The first scanning unit 251 scans the laser beam toward the second scanning unit 252. For example, the first scanning unit 251 scans the laser beam L to the sub-scanner 253 located at (1, 1) on the sub-scanning surface A for the first time, and at the same time, the sub-scanner 253 which received the laser beam L reflects the scanned laser beam L to scan the laser beam in a main scanning direction and in a sub-scanning direction onto the image unit 290 secondarily. Then, the first scanning unit 251 scans the laser beam L to the sub-scanner 253 located at (1,2) on the sub-scanning surface A, and the sub-scanner 253 which received the laser beam L scans the laser beam L secondarily onto the image unit 290 in a main scanning direction and in a sub-scanning direction. Thus, the laser beam is scanned sequentially on the divided regions of the image unit 290 in two stages such that the first scanning unit 251 finally scans the laser beam L to the sub-scanner 253 at (M,N) on the sub-scanning surface A primarily, and the sub-scanner 253 which received the laser beam L scans the laser beam L onto the image unit 290 in a main scanning direction and in a sub-scanning direction, completing formation of an image on the image unit 290. This scanning process is repeated to display images on the image unit 290.

As described above, as the scanning process is divided into two processes in the first scanning unit 251 and the second scanning unit 252, the screen can be enlarged as much as the number of the sub-scanners 253. Furthermore, as the scanning process is divided into two steps, the distance between the scanning unit 252 and the image unit 290 can be reduced and thus the laser display device can be made thinner.

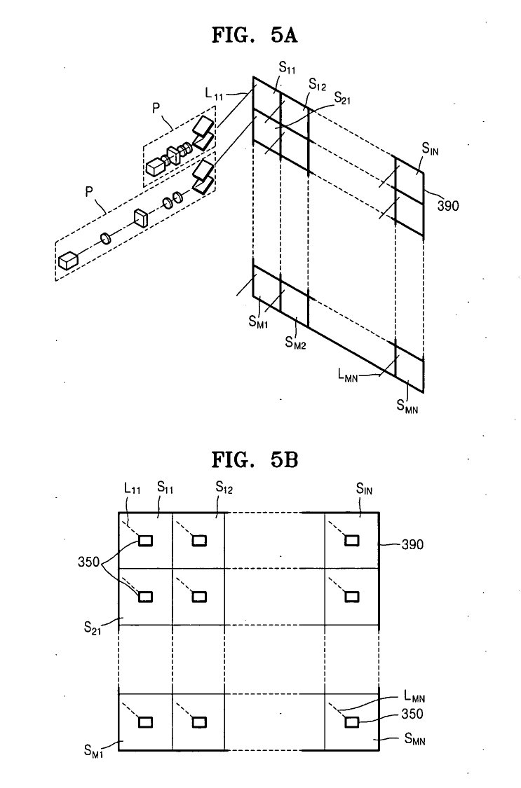

FIG. 5A is a schematic view of a laser display device according to another embodiment of the present invention. FIG. 5B is a view taken from the rear surface of an image unit, illustrating the image unit and a scanning unit. The present embodiment also illustrates a laser display device having a large screen which is applied from the embodiment of FIG. 1.

Referring to FIG. 5A, the laser display device includes an image unit 390 including M×N virtually divided regions and M×N sub-units P that are arranged at the rear surface of the image unit 390 and radiate laser beams L.

In FIG. 5A, not all of the sub-units P are illustrated.

Each of the sub-units P includes a sub-light source 300, a sub-collimating optical system 310, a sub-light modulation unit 320, a sub-focusing optical system 340, and a sub-scanning unit 350. The description of the components of the present embodiment common to those in the previous embodiment of FIG. 1 having substantially equal function and configuration are not being repeated. For simplicity of the drawing, a sub-light source 300 including one laser diode is illustrated. However, a plurality of laser diodes may be included for realizing color, and in this instance, each sub-unit P further includes a light path converter (not shown).

As shown in FIGS. 5A and 5B, the image unit 390 can be easily extended to a large screen by adding sub-units P.

In the present embodiment, M×N sub-scanning units 350 are arranged in the divided regions S11,S12, . . . ,SMN at the rear surface of the image unit 390, and each sub-scanning unit 390 scans a modulated laser beam onto the image unit 390.

The image can be realized by scanning the divided regions S11,S12, . . . ,SMN of the image unit 390 sequentially or simultaneously. For example, the sub-units P can sequentially receive an image signal generated from an image signal generation unit (not shown) to modulate the laser beam L, and sequentially scan the modulated laser beam L onto the image unit 390 to form an image. General television display methods use sequential scanning, but the present invention is not limited to this. Image signals for the entire screen can also be divided into M×N regions and the image then formed by simultaneously scanning all regions.

As described above, the laser display device according to the present invention produces an image using photoluminescence by a laser beam, thereby a high brightness and contrast ratio, and allowing the screen of the laser display device to be readily enlarged.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A laser display device comprising:
a light source emitting at least one laser beam;
a light modulation unit for modulating the laser beam emitted from the light source according to an image signal;
a scanning unit scanning the laser beam modulated in the light modulation unit in a main scanning direction and in a sub-scanning direction; and
an image unit in which an image is formed having a phosphor layer in which excitation light is generated by a laser beam scanned by the scanning unit.

2. The laser display device of claim 1, wherein the light source is a laser diode emitting UV light.

3. The laser display device of claim 1, further comprising a collimating optical system located between the light source and the light modulation unit and collimating the laser beam emitted from the light source.

4. The laser display device of claim 1, further comprising a focusing optical system focusing the laser beam modulated in the modulation unit onto the image unit.

5. The laser display device of claim 1, wherein the scanning unit comprises at least a micro-scanner having a rotatable mirror.

6. The laser display device of claim 1, wherein the image unit further comprises a UV transmitting filter that is located at a surface of incidence of the laser beam onto the phosphor layer and transmits the UV wavelength band of the laser beam.

7. The laser display device of claim 1, wherein the image unit further comprises a UV blocking filter that is located on the opposite surface of the surface of the incidence of the laser beam of the phosphor layer.

8. The laser display device of claim 1, wherein the image unit further comprises an anti-reflection layer located on the opposite surface of the surface of the incidence of the laser beam of the phosphor layer.

9. The laser display device of claim 1, wherein the phosphor layer comprises a plurality of pixels formed of red, green, and blue phosphors.

10. The laser display device of claim 9, wherein the light source emits first through third laser beams which are separated so as to respectively excite the red, green, and blue phosphors at the same time.

11. The laser display device of claim 10, further comprising a light path converter converting the light path such that the first through third laser beams which are modulated in the light modulation unit are radiated to the scanning unit.

12. The laser display device of 11, wherein the light path converter comprises a first dichroic mirror that transmits the first laser beam and reflects the second laser beam, and a second dichroic mirror that reflects the first and second laser beams and transmits the third laser beam.

13. The laser display device of claim 9, further comprising a shadow mask that is separated a predetermined distance from the phosphor layer and in which are formed a plurality of holes corresponding to the pixels formed in the phosphor layer.

14. The laser display device of claim 1, wherein the scanning unit comprises:
a first scanning unit scanning the laser beam modulated in the light modulator in a main scanning direction and in a sub-scanning direction for the first time; and
a second scanning unit that is separated a predetermined distance from the rear surface of the image unit and scans the laser beam scanned in the first scanning unit onto the image unit in a main scanning direction and in a sub-scanning direction for the second time.

15. The laser display device of claim 14, wherein the image unit has M×N divided regions, and the second scanning unit comprises N×M sub-scanners that are separated a predetermined distance from the rear surface of the image unit and arranged closely in an M×N matrix and scan the laser beam scanned by the first scanning unit onto the image unit in a main scanning direction and in a sub-scanning direction for the second time.

16. The laser display device of claim 1, wherein the image unit has M×N divided regions and the scanning unit comprises M×N sub-scanning units that are arranged at a rear surface of the image unit according to the divided regions and scan the laser beam onto the image unit in a main scanning direction and in a sub-scanning direction, and each sub-scanning unit scans a laser beam which is individually modulated.
